(19) United States
(12) Patent Application Publication
(10) Pub. No.: US 2006/0277150 A1
(43) Pub. Date: Dec. 7, 2006

(54) Method and system for recovery for an electronic voucher and content received using an electronic voucher

(76) Inventor: Franklin Selgert, Berkel en Rodenrijs (NL)

Correspondence Address: MICHAELSON & ASSOCIATES, P.O. BOX 8489, RED BANK, NJ, 07701, US

(21) Appl. No.: 10/555,979

(22) PCT Filed: May 28, 2004
(86) PCT No.: PCT/EP04/05954

§ 371 Date: Nov. 8, 2005

Related U.S. Application Data
(60) Provisional application No. 60/474,651, filed on May 30, 2003.

(51) Int. Cl. G06Q 99/00

(52) U.S. Cl. 705/51

(57) ABSTRACT

Method and system for the recovery from a content or service provider of an electronic voucher and/or electronic content received using an electronic voucher, residing on an electric circuit, for use in a communication means such as a mobile telephone, whereby at least the electric circuit has been replaced, by exchanging an identification signal between the user of the communication means and the content or service provider and subsequent transfer of the electronic vouchers and/or electronic content designated by the user to the replaced electric circuit.

### FIELD OF THE INVENTION

The present invention relates to a method and system for recovering from a content or service provider an electronic voucher and/or electronic content received using an electronic voucher, residing on an electric circuit, for use in a communication means such as a mobile telephone.

### BACKGROUND OF THE INVENTION

Vouchers are in widespread use as a means to represent purchased goods or services, discounts to be given on goods or services, services to be rendered, deposits made, etc.

The international patent application WO 00/30045 describes a method of providing a voucher as a result of an electronic payment transaction. According to this method, the voucher can also be represented electronically, for instance on a SIM card of a mobile telephone. The electronic voucher can be presented over a communication means to a central checking device. If validity of the electronic voucher is established, the user can download the content or may use a service that is made available using the electronic voucher.

Electronic vouchers can get lost. They can also be stolen together with the media on which they reside. A SIM card with a voucher residing on it or the entire mobile phone including a SIM card can be stolen, for instance. Electronic vouchers may also be destroyed or damaged on the medium or together with the medium on which they reside. In the event of loss or damage of an electronic voucher, the user can no longer obtain services or withdraw deposits, etc. which are represented by the voucher. The method according to WO 00/30045 does not provide a solution to overcome this disadvantage.

A similar problem arises with electronic content that has been received using an electronic voucher. In the event of loss of the content and/or the medium on which it resides, it also becomes desirable to be able to have available again this electronic content after the medium has been replaced.

### AIM OF THE INVENTION

It is an object of the invention to eliminate the drawbacks of the prior art and to provide a method and a system for recovering from a content or service provider an electronic voucher or electronic content received via a communications means and using an electronic voucher.

### SUMMARY OF THE INVENTION

In accordance with this invention, a method is disclosed for recovering from a content or service provider an electronic voucher and/or electronic content received using an electronic voucher, residing on an electric circuit, for use in a communication means such as a mobile telephone, whereby at least the electric circuit has been replaced by another electric circuit, by exchanging an identification signal between the user of the communication means and the content or service provider and subsequent transfer of the electronic vouchers and/or electronic content designated by the user to the electric circuit.

In a first aspect of the present invention a recovery method is disclosed for the recovery of an electronic voucher, or electronic content that was received using and electronic voucher. The electronic voucher or the electronic content was stored after being received in an electric circuit (e.g. an electric circuit on a subscriber identity module (SIM)) present in a communications means such as a mobile telephone. If the electric circuit is not available anymore (e.g. due to damages, lost or theft) for the user of the communications means, the user would like to have available again the electronic voucher(s) and/or electronic content received at an earlier stage. Having the opportunity to recover said data and information will be a benefit for the user of the communication means. In other words, the user will have more confidence in relation to the usage of electronic vouchers.

A step of the method according to the present invention is that an identification signal is exchanged between the user and the content or service provider. There are no limitations in relation to the identification signal. It can be an electrical signal but also any other type of signal. Via the identification signal the content or service provider can be informed about the identity of the user. However, the identity signal may also comprise information about the communications means such as serial numbers. The identity signal may also comprise information about the nature (type, time, etc.) of the electronic voucher(s) or electronic content earlier received be the user. Further, the identity signal may also comprise procedural related information such as an address or a selection option.

Another step of the method according to the present invention is performing a check of the identification signal and, dependant on the result of the check, sending a list to the user comprising an overview of the electronic voucher(s) and/or electronic content earlier received by the user. An advantage of this method is that the user needs not to know all the details regarding the electronic voucher(s) and electronic content received before. The user can find these details in the list received from the content or service provider.

Another step of the method is that from the list electronic vouchers or electronic content can be selected by the user, after which the selection can be sent to the content or service provider. There are no restriction in relation to the means and methods used for communicating the selection between the user and the content or service provider. In other words, the communication method which is the most preferable for the user and the content or service provider may be used. Based on the selection received, the content or service provider will sent the electronic voucher(s) and/or electronic content to the user. The received electronic voucher(s) and/or electronic content will be stored on an electrical circuit that replaces the electrical circuit that is not available anymore.

### BRIEF DESCRIPTION OF THE DRAWING FIGURE

The foregoing aspects and many of attendant advantages of this invention will become better understood by reference to the following detailed description, when taken in conjunction with the accompanying drawing, wherein:

FIG. 1 is a schematic representation of a SIM card with an electric circuit capable to accommodate an electronic voucher and/or electronic content.

FIG. 2 is a schematic illustration of an embodiment of the present invention.

### EXEMPLARY EMBODIMENTS

For the purpose of teaching of the invention, preferred embodiments of the method and devices of the invention are described in the sequel. It will be apparent to the person skilled in the art that other alternative and equivalent embodiments of the invention can be conceived and reduced to practice without departing form the true spirit of the invention, the scope of the invention being limited only by the appended claims as finally granted.

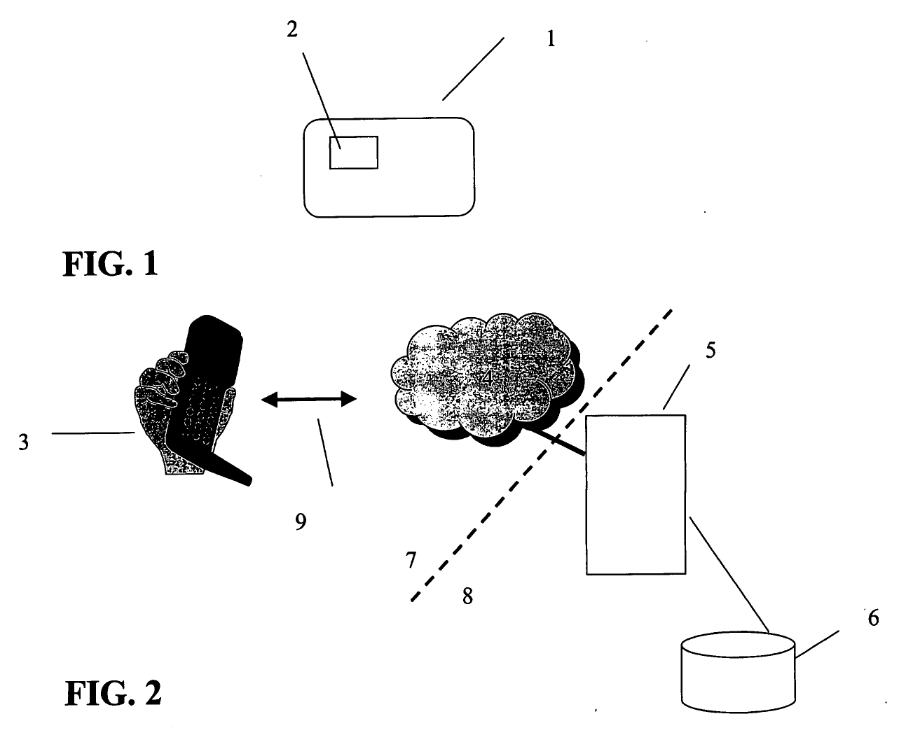

FIG. 1 schematically depicts a SIM card 1. SIMs (Subscriber Identity Modules) are used in mobile telephones to identify a subscriber or user. The SIM card can be arranged in a mobile telephone. On the SIM card 1 is an electric circuit 2, which is capable of storing data including one or more electronic vouchers and/or electronic content. It may be clear that it is not necessarily that the electric circuit resides on a SIM card. The electric circuit may instead or additionally be present in any other part of the communications means such as a mobile telephone. An electronic voucher represents purchased goods or services, discounts to be given on goods or services, services to be rendered, deposits made, for instance. Electronic content includes data and/or programs for use in the mobile telephone.

When a user needs to replace his mobile telephone due to loss, damage, theft, etc., the user would like to have available again the electronic voucher or vouchers and/or the content that was deposited in the mobile telephone prior to the replacement.

Referring now to FIG. 2, an electronic voucher and/or electronic content can be recovered according to the present invention by means of a mobile telephone 3 that has been replaced due to loss, damage, theft, etc. The mobile telephone 3 is connected to a mobile network 4 that is part of a domain 7 of a mobile telecom provider. A domain 8 of a content provider or service provider comprises a server 5 that can verify the validity of electronic vouchers. The server 5 also may be able to handle electronic payments. Yet other possible functions of the server 5 include identification and authentication. The server 5 is connected to a storing means 6 for storing information relating to users, electronic vouchers, as well as content, services or goods that are purchased by users or are to be delivered to users.

The system and method according to the present invention is capable of exchanging an identification signal 9 between the user and the content or service provider. The identification signal 9 can be an electrical signal, such as a series of ‘0’'s and ‘1’'s. The identification signal 9 may also be a speech signal or information that is written or otherwise represented. The identification signal 9 can be transmitted via the network 4 in domain 7 between the mobile telephone 3 and the server 5 in domain 8. However, it is also be possible that the identification signal is transmitted between the user and the content or service provider in any appropriate way, such as postal services. The identification signal 9 can also be transmitted both ways, i.e. from the user to the content or service provider and vice versa.

According to the present invention, if a user has replaced his mobile telephone due to loss, damage, theft, etc., then there will be an exchange of the identification signal 9 between the user and the content or service provider. The identification signal can comprise information about the user and/or information about the mobile telephone 3.

In an embodiment of the present invention, the server 5 will check the identification signal 9. After checking the identification signal, the content or service provider will send a list comprising an overview of electronic vouchers received by the user and/or content downloaded by the user prior to the replacement. The list can be presented to the user on the mobile telephone, although the list could also be presented via another medium such as the internet. Further information may be added to the list.

From the list, the user can select one or more entries that represent content and/or electronic vouchers. The selection is sent to the content or service provider. Another identification signal, not depicted in FIG. 2, could be sent in addition to the selection to the content or service provider.

After having received the selection from the user, the content or service provider sends one or more electronic vouchers and/or content to the mobile telephone 3 of the user. In the mobile telephone 3 there is an electric circuit (2′) that replaces electric circuit (2). The received vouchers and/or content is then stored in the electric circuit (2′). Measures could be taken by the content or service provider to prevent electronic vouchers and/or content residing in the mobile telephone that is no longer available to the user due to loss, damage, theft, etc. from being used.

1. Method for recovering from a content or service provider an electronic voucher and/or electronic content received using an electronic voucher, residing on an electric circuit (2), for use in a communication means such as a mobile telephone (3), whereby at least the electric circuit (2) has been replaced by another electric circuit (2′), by exchanging an identification signal (9) between the user of the communication means and the content or service provider and subsequent transfer of the electronic vouchers and/or electronic content designated by the user to the electric circuit (2′).

2. Method according to claim 1, whereby the electric circuit (2) resides on a SIM card (1).

3. Method according to claim 1, wherein information concerning the electronic voucher and/or the electronic content is held in a server (5).

4. Method according to claim 3, wherein the identification signal (9) is checked by the server (5).

5. Method according to claim 3, wherein the server (5) is capable to handle electronic payments.

6. Method according to claim 3, wherein the server (5) is capable to handle identification and authentication.

7. Method according to claim 1, wherein the identification signal (9) is an electric signal.

8. Method according to claim 1, wherein the identification signal (9) is a speech signal.

9. Method according to claim 1, wherein the identification signal (9) is transmitted from the content or service provider to the user of the communication means.

10. Method according to claim 1, wherein the identification signal (9) is transmitted from the user of the communication means to the content or service provider and is also transmitted from the content- or service provider to the user of the communication means.

11. Method according to claim 1, wherein a list of recoverable electronic vouchers and/or electronic content is presented for designation on the communication means.

12. Method according to claim 1, wherein a list of recoverable electronic vouchers and/or electronic content is presented for designation on the Internet.

13. Method according to claim 11, wherein the designation of electronic vouchers and/or electronic content for recovery includes another identification signal.

14. System for recovering from a content- or service provider an electronic voucher and/or electronic content received using an electronic voucher, residing on an electric circuit (2), for use in a communication means such as a mobile telephone (3), whereby at least the electric circuit (2) has been replaced by another electric circuit (2′), comprising means for exchanging an identification signal between the user of the communication means and the content or service provider and means for transferring of the electronic vouchers and/or electronic content designated by the user to the electric circuit (2′).

15. System according to claim 14, whereby the electric circuit (2) resides on a SIM card (1).

16. System according to claim 14, wherein information concerning the electronic voucher and/or the electronic content is held in a server (5).

17. System according to claim 16, wherein the identification signal (9) is checked by the server (5).

18. System according to claim 16, wherein the server (5) is capable to handle electronic payments.

19. System according to claim 16, wherein the server (5) is capable to handle identification and authentication.

20. System according to claim 14, wherein the identification signal (9) is an electrical signal.

21. System according to claim 14, wherein the identification signal (9) is a speech signal.

22. System according to claim 14, wherein the identification signal (9) is transmitted from the content or service provider to the user of the communication means.

23. System according to claim 14, wherein the identification signal (9) is transmitted from the user of the communication means to the content- or service provider and is also transmitted from the content or service provider to the user of the communication means.

24. System according to claim 14, wherein a list of recoverable electronic vouchers and/or electronic content is presented for designation on the communication means.

25. System according to claim 14, wherein a list of recoverable electronic vouchers and/or electronic content is presented for designation on the internet.

26. System according to claim 24, wherein the designation of electronic vouchers and/or electronic content for recovery includes another identification signal.
